(19) United States
(12) Patent Application Publication
(10) Pub. No.: US 2026/0156198 A1
(43) Pub. Date: Jun. 4, 2026

(54) ASYNCHRONOUS REAL-TIME DELIVERY OF LOCALIZED STRINGS

(71) Applicants: DISNEY ENTERPRISES, INC., Burbank, CA (US); HULU, LLC, Santa Monica, CA (US)

(72) Inventors: Darshana UMAKANTH, Culver City, CA (US); Gerardo LOPEZ HERNANDEZ, Los Angeles, CA (US); Alan T. GOATES, Santa Cruz, CA (US); Osama Ased FAROOQI, Dix Hills, NY (US); Joshua M. MCDONNELL, Fairfield, CT (US); David Heehoon JUNG, Seattle, WA (US)

(21) Appl. No.: 19/402,277

(22) Filed: Nov. 26, 2025

Related U.S. Application Data
(60) Provisional application No. 63/727,558, filed on Dec. 3, 2024.

(51) Int. Cl. H04L 67/52; G06F 9/451; G06F 40/242

(52) U.S. Cl. CPC H04L 67/52; G06F 9/454; G06F 40/242

(57) ABSTRACT

The present invention sets forth techniques for the asynchronous delivery of localized textual elements to a client device, where each client device is executing a user session having an associated user context. The client device sends a request for a textual element, including a dictionary key associated with the textual element and a specification of the user context. The techniques receive the request, dictionary key, and user context, and select one of a plurality of virtual dictionaries based on the user context. The techniques then locate the dictionary key within the selected virtual dictionary and retrieve a key value associated with the dictionary key. The key value represents a localized translation of the requested textual element, and is transmitted to the client device for display to the user. Changes to one or more dictionary key values may be propagated to the client device in near real-time.

### CROSS-REFERENCE TO RELATED APPLICATIONS

This application claims priority benefit of U.S. Provisional application titled “ASYNCHRONOUS REAL-TIME DELIVERY OF LOCALIZED STRINGS,” filed Dec. 3, 2024, and having Ser. No. 63/727,558. This subject matter of this related application is hereby incorporated by reference in its entirety.

### BACKGROUND

### Field of the Various Embodiments

Embodiments of the present disclosure relate generally to providing localized versions of textual content and, more specifically, to techniques for asynchronous delivery of localized textual elements, such as strings.

### Description of the Related Art

In the fields of content creation and content delivery, content creators and/or distributors may wish to localize one or more textual elements. For example, textual elements associated with one or more application content items, such as pages, menus, or screens, may be localized based on a user's preferred language or geographic region. A particular application content item may include one or more localized textual elements, such as menu titles, menu options, alerts, announcements, or descriptions.

Existing techniques for localizing textual elements included in an application may require manually generating and publishing multiple different versions of an application content item, where each version includes textual elements associated with a different specific localization option. For example, a content provider may manually generate multiple different versions of a content selection page, where each version is localized based on a different available language. After a given localized version is generated, each string in the localized version may be manually linked to a corresponding portion of the content selection page for subsequent publication. One drawback to these techniques is that they may require generating, storing, tracking, and maintaining multiple different versions of a single application content item across discrete computer-based tools and/or services, which introduces significant time and resource overhead. Further, each different version of an application content item is generated based on an existing localization option, such as a particular language. When a new localization option becomes available, content distributors may be required to repeat the process of generating and linking new versions for each of multiple application content items, where each new version includes localized textual elements based on the newly available localization option.

As the foregoing illustrates, what is needed in the art are more effective techniques for the generation and delivery of localization data within an application.

### SUMMARY

One embodiment of the present invention sets forth techniques for delivering localized textual elements. The techniques include matching a request from a client device for one or more textual elements to one or more dictionary keys stored in a global translation store. The techniques also include determining one or more key values corresponding to the one or more dictionary keys based on a user context associated with a user session on the client device, and transmitting the one or more key values as localized versions of the one or more textual elements to the client device, wherein the localized versions are outputted by the client device during the user session.

One technical advantage of the disclosed techniques relative to the prior art is that the disclosed techniques are operable to generate and publish content items that are not restricted to a particular localization option. Further, the disclosed techniques are operable to automatically associate newly available localization data with existing content items, without requiring the creation and linking of additional, localization-specific versions of the content items. The disclosed techniques decouple the creation and distribution of localization data from the design of content items by incorporating dictionary key references in content items while separately generating translations or other localizations associated with the referenced dictionary keys. This separation of content creation and localization enables streamlined resolution and delivery of localization data. Additionally, the disclosed techniques allow localization to be performed in a more flexible and/or granular manner than conventional approaches that involve manually generating and linking different localized versions of textual elements to corresponding locations of a content item for publication. Further, by centralizing localized versions of referenced dictionary keys, the disclosed techniques require fewer computing resources to generate, store, and transmit content items. These technical advantages provide one or more improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present invention.

FIG. 2 is a more detailed illustration of the localization engine of FIG. 1, according to some embodiments.

FIG. 3 is an example user interface screen, according to some embodiments.

FIG. 4 is a flow diagram of method steps for performing localization of textual elements in an application or system, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

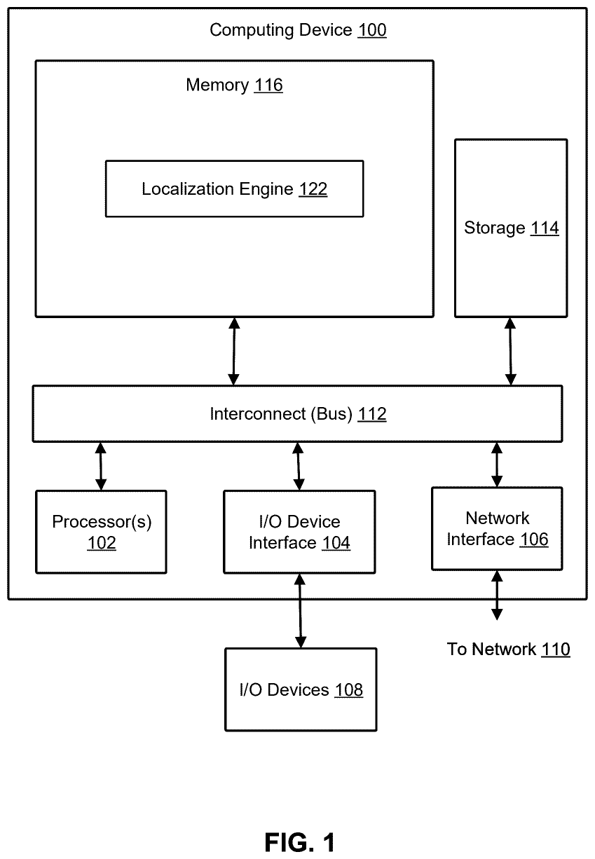

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run localization engine 122 that resides in a memory 116.

It is noted that the computing device described herein is illustrative and that any other technically feasible configurations fall within the scope of the present disclosure. For example, multiple instances of localization engine 122 could execute on a set of nodes in a distributed and/or cloud computing system to implement the functionality of computing device 100. In another example, localization engine 122 could execute on various sets of hardware, types of devices, or environments to adapt localization engine 122 to different use cases or applications. In a third example, localization engine 122 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Localization engine 122 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including localization engine 122.

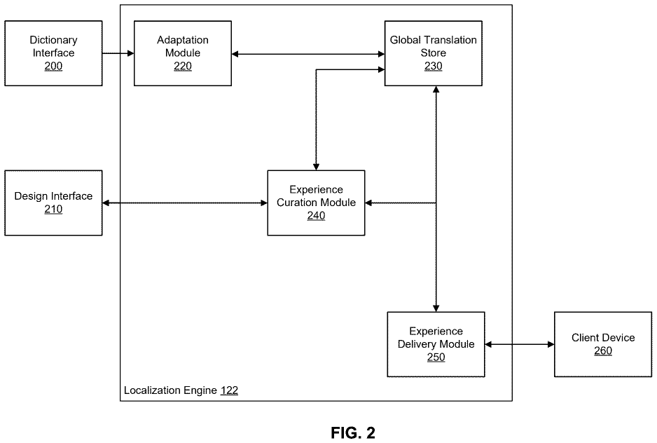

FIG. 2 is a more detailed illustration of localization engine 122 of FIG. 1, according to some embodiments. Localization engine 122 transmits localized content items, including localized textual elements, to client device 260 based on dictionary interface 200 and design interface 210. Localization engine 122 includes, without limitation, adaptation module 220, global translation store 230, experience curation module 240, and experience delivery module 250.

In at least one embodiment, dictionary interface 200 includes a computer interface through which localization engine 122 receives dictionary input, such as the creation, modification, or deletion of dictionary keys and/or key values. In various embodiments, a dictionary key may include a textual element associated with a content item, such as a page title, heading, menu title, or menu item. In at least one embodiment, a dictionary key may include an English expression of the associated textual element, while each of one or more key values associated with the dictionary key may include an expression of the same textual element in a different language or in a different English dialect. Each key may also be associated with a unique key identifier.

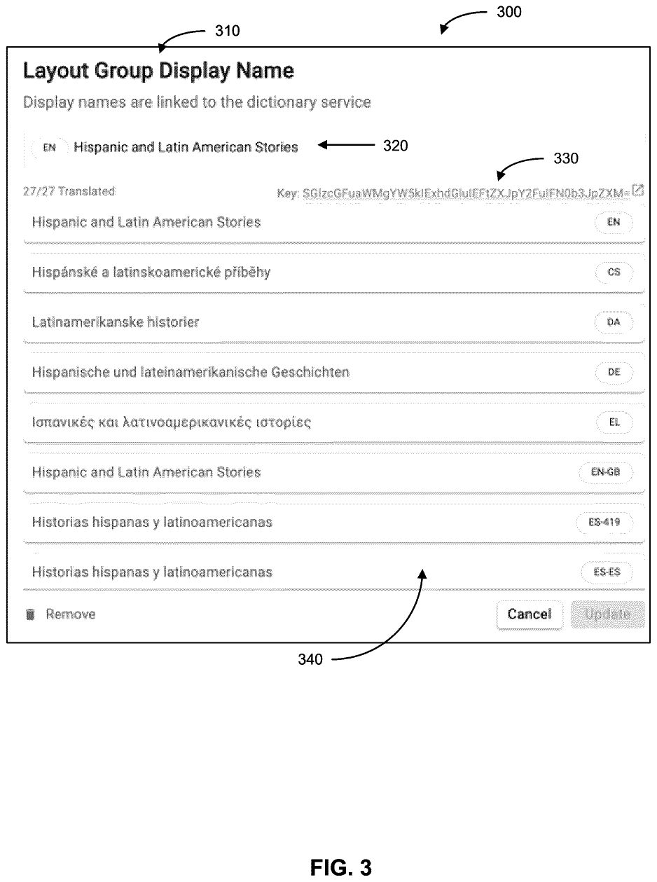

Turning now to FIG. 3, FIG. 3 depicts an example user interface screen 300, according to some embodiments. User interface screen 300 includes, without limitation, a content item description 310, a dictionary key 320 associated with the content item description, a unique key identifier 330 associated with dictionary key 320, and one or more key values 340 associated with dictionary key 320.

Content item description 310 includes a textual description of a content item type associated with dictionary key 320. As shown, content item description 310 describes dictionary key 320 as a “Layout Group Display Name” type, such as might be displayed within a content item included in a content delivery platform to describe a displayed collection of media content items having a similar theme and/or other shared characteristics. Other instances of content item description 310 may include, for example, “Menu Title,” “Menu Item,” or “Platform Page Title.” Although examples given in the description of various embodiments may relate to a content delivery platform and/or media content items, these examples are not intended to be limiting. The disclosed techniques are operable to receive, store, and provide localization data, including localized textual elements, for use within a variety of systems and/or applications, including but not limited to media content delivery platforms, Automated Teller Machines (ATMs), Point-of-Sale (POS) systems, informational kiosks, mailing list management systems for paper and/or electronic mail, or online restaurant menus.

Dictionary key 320 includes a text string associated with content item description 310, such as the depicted string “Hispanic and Latin American Stories.” In various embodiments, the associated text string may be expressed in a predetermined default language, such as English. This example is not intended to be limiting, and various embodiments may include any chosen default language. In at least one embodiment, the same default language is used for any content item description 310 associated with an instance of dictionary key 320.

Dictionary key 320 is associated with unique key identifier 330. In various embodiments, localization engine 122 may determine a value for an instance of unique key identifier 330 based on text associated with dictionary key 320. For example, unique key identifier 330 includes a Base64 representation of the text string “Hispanic and Latin American Stories” associated with dictionary key 320. Localization engine 122 may generate unique key identifier 330 using any suitable generation technique, such as the Base64 conversion shown, a conversion into a different base representation, or a hashing technique.

An instance of dictionary key 320 includes one or more key values, such as key value 340. As shown in FIG. 3, key value 340 includes a translation of the text string associated with dictionary key 320 into a different language and/or dialect. Specifically, key value 340 includes a translation of the text string “Hispanic and Latin American Stories” into the language designated by the ISO 639-1 language code “ES-ES” (Spanish as spoken in Spain). Other keys depicted in FIG. 3 show translations of the text string into Danish (ISO 639-1 code “DA”), German (ISO 639-1 code “DE”), and Spanish as spoken in Latin American and the Caribbean (ISO 639-1 code “ES-419”).

Returning to FIG. 2, dictionary interface 200 may include one or more I/O devices, such as I/O devices 108 of computing device 100 described herein. In various embodiments, dictionary interface 200 may receive dictionary input from a human user via, e.g., a Graphical User Interface (GUI). Alternatively or additionally, dictionary interface 200 may receive dictionary input from an upstream software application via a network interface, such as network 110 described herein. Localization engine 122 transmits the received dictionary input to adaptation module 220.

In at least one embodiment, adaptation module 220 receives dictionary input that directs the creation, modification, and/or deletion of one or more dictionary keys or key values. Adaptation module 220 may store dictionary keys and associated key values in global translation store 230. As discussed in the detailed description of FIG. 3, adaptation module 220 may associate a dictionary key with a particular textual element included in a content item. For example, a textual element may include a page title associated with a page included in a browsable interface within an application. As discussed herein, a dictionary key may include an associated unique key identifier 330, and may be associated with one or more key values 340, where each key value 340 may include a translation of dictionary key 320 into a specific language or dialect.

In various embodiments, global translation store 230 includes one or more instances of dictionary key 320, and one or more instances of key value 340 associated with each instance of dictionary key 320. Each instance of key value 340 included in global translation store 230 may also be associated with context metadata received via dictionary interface 200, where the context metadata associated with a key value describes a set of context values associated with a subset of users of an application or system. In various embodiments, experience delivery module 250 discussed herein may select an instance of key value 340 for presentation to a user based on context metadata associated with the instance of key value 340 and context value associated with the user. Context values may include one or more of a geographic region associated with the user, a particular hardware and/or software environment associated with the user's interaction with the application or system, and/or user membership in one or more defined groups, e.g., adult, unrestricted, age-restricted, or time-restricted. Context values may also include one or more privileges, entitlements, or offers associated with the user or with a particular content item within the application or system. One or more context values may be expressly specified by the user, such as one or more user-specified preferred content genres within a media content delivery platform. Additionally or alternatively, one or more context values may be specific to a device or platform and/or inferred from other context values and/or user characteristics. For example, localization engine 122 may infer a location and/or geographic region associated with a user based on an Internet Protocol (IP) address associated with the user. The above examples of context values are not intended to be limiting, and additional context values associated with one or more of a user, a user session, a user environment, a media content delivery platform, or a media content item are contemplated within the scope of this disclosure. In various embodiments, a set of context values may be modifiable and extensible, such that context values may be added, deleted, and/or modified.

Localization engine 122 transmits the contents of global translation store 230 to experience curation module 240 and experience delivery module 250. Responsive to an addition, deletion, or modification of one or more dictionary keys included in global translation store 230, localization engine 122 may transmit the additions, deletions, or modifications to experience curation module 240 and/or experience delivery module 250 in real time or near-real time.

In various embodiments, experience curation module 240 describes content items, including but not limited to, page titles, menu titles, menu items, or descriptive labels associated with a media content item or with a group of media content items. For example, experience curation module 240 may include a content delivery platform item of the type “Page Title” with the value “Newly Added TV Shows,” or the descriptive label “Continue Watching” associated with a horizontally scrollable row of media content items. Each content delivery platform item includes an associated dictionary key 320. In the above examples, “Newly Added TV Shows” and “Continue Watching” represent instances of dictionary key 320 associated with their respective content delivery platform items.

Experience curation module 240 may also include one or more media content items, such as movies, television shows, recorded concerts, podcasts, or documentaries. Each media content item may include one or more associated instances of dictionary key 320. For example, instances of dictionary key 320 associated with a media content item may include one or more of a title, a description, a cast list, a duration, or a genre.

In various embodiments, each content item described in experience curation module 240 may include an associated context specifying a subset of users exhibiting one or more specified user characteristics as described herein. For example, some content items may only be displayed to users who are located within a particular geographic region, to users who belong to a specified group, such as “adult,” or to users associated with one or more specified privileges, entitlements, and/or offers.

In various embodiments, design interface 210 enables the viewing, addition, deletion, or modification of one or more content items included in experience curation module 240. Localization engine 122 may receive design input from a human user and/or an upstream software application via design interface 210. Design interface 210 may include the same GUI and/or I/O devices 108 as dictionary interface 200 described herein, and may execute on the same computing system or computing environment as dictionary interface 200. In other embodiments, design interface 210 may execute on a different computing system or computing environment than dictionary interface 200. Localization engine 122 may transmit any additions, deletions, and/or modifications of experience curation module 240 to experience delivery module 250.

In various embodiments, experience delivery module 250 presents one or more content items to a user via client device 260 described herein, based on a context associated with the user. For example, in response to input received from client device 260, experience delivery module 250 may present localized versions of one or more of a menu, a menu item, a page, a media content item, or a grouping of media content items.

Experience delivery module 250 presents localized versions of textual elements associated with the one or more content items, based on the context values associated with the user and the received contents of global translation store 230. For example, responsive to user input, experience delivery module 250 may transmit content items to client device 260, where the content items include a page having a page title and one or more media content items. Based on dictionary keys associated with the content items from experience curation module 240, global translation store 230, and context values associated with the user, experience delivery module 250 retrieves translations for each of the keys associated with the content items.

In various embodiments, experience delivery module 250 partitions the received contents of global translation store 230 into multiple, context-specific virtual dictionaries. Each of the multiple virtual dictionaries may include instances of key value 340 associated with a particular combination of user context values. Experience delivery module 250 may partition global translation store 230 in a denormalized manner, in which each of multiple virtual dictionaries may include redundant copies of data stored in global translation store 230. This redundancy may improve the performance of experience delivery module 250 when retrieving key values from the virtual dictionaries. Experience delivery module 250 applies the user context values as selection and/or filtering criteria, and selects a corresponding key value 340 for each content item key from the virtual dictionaries. Responsive to further user input including a selection of a specific media content item included in the displayed page, experience delivery module 250 may similarly select key values 340 from the virtual dictionaries and generate translations for each dictionary key associated with the specific media content item, such as a description or a genre. Experience delivery module 250 may transmit a content item including a page associated with the specific media content item to client device 260, including the localized dictionary key values associated with the media content item's dictionary keys.

In various embodiments, client device 260 may include any suitable hardware and/or software environment operable to receive input from a user and transmit content items to the user. Client device 260 may include, but is not limited to, a smart television, desktop computer, portable computer, smart watch, portable telephone, a set-top box connected to a television, media stick or dongle designed to interface with a television, Automated Teller Machine (ATM), informational kiosk, and/or Point-of-Sale (POS) system. Client device 260 may receive user input via one or more of a keyboard, mouse, trackball, voice input, gesture, tablet interface, or Virtual Reality/Augmented Reality (VR/AR) device. Client device 260 may transmit content items to the user via one or more of a monitor display, projector, portable telephone display, or a Head-Mounted Device (HMD).

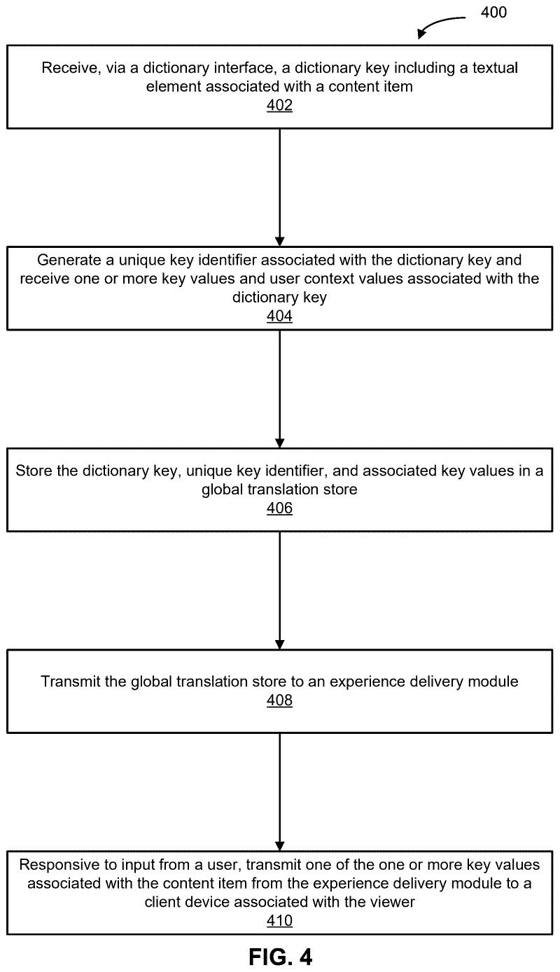

FIG. 4 is a flow diagram of method steps for performing localization of textual elements in an application or system, according to some embodiments. Although the method steps are described in conjunction with the systems of FIGS. 1-2, persons skilled in the art will understand that any system configured to perform the method steps in any order falls within the scope of the present disclosure.

As shown, in step 402 of method 400, localization engine 122 receives, via dictionary interface 200, a dictionary key 320 including a textual element associated with a content item. The textual element associated with dictionary key 320 may include a page title, menu title, menu item description, or a descriptive label associated with a media content item or a group of media content items. In various embodiments, the textual element associated with dictionary key 320 may be expressed in a default language, such as English. Localization engine 122 may also receive one or more key values 340 associated with dictionary key 320, where each of the one or more key values 340 includes a translation of the textual element into a different language or dialect.

At step 404, adaptation module 220 of localization engine 122 generates a unique key identifier 330 associated with dictionary key 320. Adaptation module 220 receives one or more instances of key value 340 and one or more user context values associated with each instance of dictionary key 320. In various embodiments, adaptation module 220 may convert the default language expression of dictionary key 320 into a Base64 representation, and set unique key identifier 330 equal to the Base64 representation of dictionary key 320. Each instance of key value 340 may include a translation of dictionary key 320 intro a different language or dialect.

User context values may include one or more user context characteristics and specified values for each of the one or more user context characteristics. For example, a user characteristic may describe a user's geographic region, and the associated specified value may include a specific geographic region, such as North America. Additional user characteristics may include a more specific user location, a user age or age range, one or more groups associated with a user, such as “adult,” “unrestricted,” or “time-restricted,” and/or one or more privileges, entitlements, or offers associated with the user.

At step 406, adaptation module 220 stores dictionary key 320, unique key identifier 330, and the one or more key values 340 in global translation store 230. As described herein, adaptation module 220 stores user context values associated with a particular key value 340 as metadata for the particular key value 340.

At step 408, localization engine 122 automatically transmits global translation store 230 to experience delivery module 250. As discussed herein, global translation store 230 includes multiple different instances of dictionary key 320, and a unique key identifier 330 associated with each instance of dictionary key 320. Global translation store 230 also includes one or more key values 340 associated with each instance of dictionary key 320, and user context metadata associated with each instance of key value 340. In various embodiments, localization engine 122 may transmit additions, deletions, and/or modifications associated with a dictionary to experience delivery module 250 in real time or near-real time upon completion of the addition, deletion, and/or modification.

At step 410, experience delivery module 250 of localization engine 122 transmits one or more key values 340 associated with a content item and stored in global translation store 230 to client device 260 associated with a user, responsive to input received from the user via client device 260. Experience delivery module 250 generates a plurality of user context-specific virtual dictionaries by partitioning global translation store in a denormalized fashion to improve the performance of experience delivery module 250 while retrieving key values 340.

For each content item presented to the user, experience delivery module 250 identifies a dictionary key 320 that includes a textual element associated with the content item and retrieves an associated key value 340 from one of the plurality of virtual dictionaries. selected based on user context values associated with the user. From within the selected virtual dictionary, experience delivery module 250 selects a key value 340 associated with dictionary key 320 by filtering multiple instances of key value 340 based on the user context values associated with the user, e.g., a preferred language associated with the user. Experience delivery module 250 transmits the selected key values to client device 260, where the selected key values include localized translations of the textual element associated with the content item.

1. In some embodiments, a computer-implemented method for delivering localized data, the computer-implemented method comprises matching a request from a client device for one or more textual elements to one or more dictionary keys stored in a dictionary, determining one or more key values corresponding to the one or more dictionary keys based on a user context associated with a user session on the client device, and transmitting the one or more key values as localized versions of the one or more textual elements to the client device, wherein the localized versions are outputted by the client device during the user session.

2. The computer-implemented method of clause 1, further comprising receiving the one or more key values and one or more context values included in the user context, and storing, in the dictionary, the one or more key values and the one or more context values in association with the one or more dictionary keys.

3. The computer-implemented method of clauses 1 or 2, wherein each of the one or more dictionary keys is associated with a unique key identifier.

4. The computer-implemented method of any of clauses 1-3, wherein each of the one or more key values corresponding to a single dictionary key included in the one or more dictionary keys includes an expression of the single dictionary key in a different language or dialect.

5. The computer-implemented method of any of clauses 1-4, wherein the user context includes one or more of a geographic region, a location, a hardware environment, a software environment, an age, a preference, a group, a privilege, an entitlement, or an offer.

6. The computer-implemented method of any of clauses 1-5, wherein the dictionary is one of a plurality of virtual dictionaries, and a dictionary key included in the one or more dictionary keys appears in more than one virtual dictionary included in the plurality of virtual dictionaries.

7. The computer-implemented method of any of clauses 1-6, wherein the client device is included in a media content delivery platform.

8. The computer-implemented method of any of clauses 1-7, wherein each of the one or more dictionary keys is expressed in a specified default language.

9. The computer-implemented method of any of clauses 1-8, wherein each of the one or more textual elements is included in a content item associated with an application executing on the client device.

10. The computer-implemented method of any of clauses 1-9, wherein the content item includes a page, a menu, or a screen, and each of the one or more textual elements includes a menu title, menu option, alert, announcement, or description.

11. In some embodiments, one or more non-transitory, computer-readable media store instructions that, when executed by one or more processors, cause the one or more processors to perform the steps of matching a request from a client device for one or more textual elements to one or more dictionary keys stored in a dictionary, determining one or more key values corresponding to the one or more dictionary keys based on a user context associated with a user session on the client device, and transmitting the one or more key values as localized versions of the one or more textual elements to the client device, wherein the localized versions are outputted by the client device during the user session.

12. The one or more non-transitory, computer-readable media of clause 11, wherein the instructions further cause the one or more processors to perform the steps of receiving the one or more key values and one or more context values included in the user context, and storing, in the dictionary, the one or more key values and the one or more context values in association with the one or more dictionary keys.

13. The one or more non-transitory, computer-readable media of clauses 11 or 12, wherein each of the one or more dictionary key values corresponding to a single dictionary key included in the one or more dictionary keys includes an expression of the single dictionary key in a different language or dialect.

14. The one or more non-transitory, computer-readable media of any of clauses 11-13, wherein the user context includes one or more of a geographic region, a location, a hardware environment, a software environment, an age, a preference, a group, a privilege, an entitlement, or an offer.

15. The one or more non-transitory, computer-readable media of any of clauses 11-14, wherein the client device is included in a media content delivery platform.

16. The one or more non-transitory, computer-readable media of any of clauses 11-15, wherein each of the one or more dictionary keys is expressed in a specified default language.

17. The one or more non-transitory, computer-readable media of any of clauses 11-16, wherein each of the one or more textual elements is included in a content item associated with an application executing on the client device.

18. The one or more non-transitory, computer-readable media of any of clauses 11-17, wherein the content item includes a page, a menu, or a screen, and each of the one or more textual elements includes a menu title, menu option, alert, announcement, or description.

19. In some embodiments, a system comprises one or more memories storing instructions, and one or more processors for executing the instructions to match a request from a client device for one or more textual elements to one or more dictionary keys stored in a dictionary, determine one or more key values corresponding to the one or more dictionary keys based on a user context associated with a user session on the client device, and transmit the one or more key values as localized versions of the one or more textual elements to the client device, wherein the localized versions are outputted by the client device during the user session.

20. The system of clause 19, wherein the processors further execute the instructions to receive the one or more key values and one or more context values included in the user context, and store, in the dictionary, the one or more key values and the one or more context values in association with the one or more dictionary keys.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for delivering localized data, the computer-implemented method comprising:
matching a request from a client device for one or more textual elements to one or more dictionary keys stored in a dictionary;
determining one or more key values corresponding to the one or more dictionary keys based on a user context associated with a user session on the client device; and
transmitting the one or more key values as localized versions of the one or more textual elements to the client device, wherein the localized versions are outputted by the client device during the user session.

2. The computer-implemented method of claim 1, further comprising:
receiving the one or more key values and one or more context values included in the user context; and
storing, in the dictionary, the one or more key values and the one or more context values in association with the one or more dictionary keys.

3. The computer-implemented method of claim 1, wherein each of the one or more dictionary keys is associated with a unique key identifier.

4. The computer-implemented method of claim 1, wherein each of the one or more key values corresponding to a single dictionary key included in the one or more dictionary keys includes an expression of the single dictionary key in a different language or dialect.

5. The computer-implemented method of claim 1, wherein the user context includes one or more of a geographic region, a location, a hardware environment, a software environment, an age, a preference, a group, a privilege, an entitlement, or an offer.

6. The computer-implemented method of claim 1, wherein the dictionary is one of a plurality of virtual dictionaries, and a dictionary key included in the one or more dictionary keys appears in more than one virtual dictionary included in the plurality of virtual dictionaries.

7. The computer-implemented method of claim 1, wherein the client device is included in a media content delivery platform.

8. The computer-implemented method of claim 1, wherein each of the one or more dictionary keys is expressed in a specified default language.

9. The computer-implemented method of claim 1, wherein each of the one or more textual elements is included in a content item associated with an application executing on the client device.

10. The computer-implemented method of claim 9, wherein the content item includes a page, a menu, or a screen, and each of the one or more textual elements includes a menu title, menu option, alert, announcement, or description.

11. One or more non-transitory, computer-readable media storing instructions that, when executed by one or more processors, cause the one or more processors to perform the steps of:
matching a request from a client device for one or more textual elements to one or more dictionary keys stored in a dictionary;
determining one or more key values corresponding to the one or more dictionary keys based on a user context associated with a user session on the client device; and
transmitting the one or more key values as localized versions of the one or more textual elements to the client device, wherein the localized versions are outputted by the client device during the user session.

12. The one or more non-transitory, computer-readable media of claim 11, wherein the instructions further cause the one or more processors to perform the steps of:
receiving the one or more key values and one or more context values included in the user context; and
storing, in the dictionary, the one or more key values and the one or more context values in association with the one or more dictionary keys.

13. The one or more non-transitory, computer-readable media of claim 11, wherein each of the one or more dictionary key values corresponding to a single dictionary key included in the one or more dictionary keys includes an expression of the single dictionary key in a different language or dialect.

14. The one or more non-transitory, computer-readable media of claim 11, wherein the user context includes one or more of a geographic region, a location, a hardware environment, a software environment, an age, a preference, a group, a privilege, an entitlement, or an offer.

15. The one or more non-transitory, computer-readable media of claim 11, wherein the client device is included in a media content delivery platform.

16. The one or more non-transitory, computer-readable media of claim 11, wherein each of the one or more dictionary keys is expressed in a specified default language.

17. The one or more non-transitory, computer-readable media of claim 11, wherein each of the one or more textual elements is included in a content item associated with an application executing on the client device.

18. The one or more non-transitory, computer-readable media of claim 17, wherein the content item includes a page, a menu, or a screen, and each of the one or more textual elements includes a menu title, menu option, alert, announcement, or description.

19. A system comprising:
one or more memories storing instructions; and
one or more processors for executing the instructions to:
match a request from a client device for one or more textual elements to one or more dictionary keys stored in a dictionary;
determine one or more key values corresponding to the one or more dictionary keys based on a user context associated with a user session on the client device; and
transmit the one or more key values as localized versions of the one or more textual elements to the client device, wherein the localized versions are outputted by the client device during the user session.

20. The system of claim 19, wherein the processors further execute the instructions to:
receive the one or more key values and one or more context values included in the user context; and
store, in the dictionary, the one or more key values and the one or more context values in association with the one or more dictionary keys.
